(19) United States
(12) Patent Application Publication
(10) Pub. No.: US 2018/0299013 A1
(43) Pub. Date: Oct. 18, 2018

(54) ROTARY SEAL ARRANGEMENT AND ROTARY SEAL WITH HELICAL SPRING SEALING ELEMENT

(71) Applicant: Trelleborg Sealing Solutions Germany GmbH, Stuttgart (DE)

(72) Inventors: Martin Franz, Wannweil (DE); Christoph Wehmann, Stuttgart (DE); Gert Mølsted Iversen, Helsingor (DK); Monica Crudu, Stuttgart (DE); Bernhard Hahn, Esslingen (DE); Matthias Keck, Renningen (DE)

(21) Appl. No.: 16/015,136

(22) Filed: Jun. 21, 2018

Related U.S. Application Data
(63) Continuation of application No. PCT/EP2016/080748, filed on Dec. 13, 2016.

(30) Foreign Application Priority Data
Dec. 23, 2015 (DE) 10 2015 226 691.5

(51) Int. Cl. F16J 15/16; F16J 15/24

(52) U.S. Cl. CPC F16J 15/164; F16J 15/3296; F16J 15/24

(57) ABSTRACT

A rotary seal arrangement includes two machine parts arranged to be rotatable relative to one another about an axis of rotation. One of the two machine parts forms a seal retaining structure and the respective other of the two machine parts forms a sealing surface. A rotary seal is formed between the two machine parts with an elastically deformable retaining element of the one machine part and with a sealing element which bears in a sealing manner with a surface pressure against the sealing surface of the other machine part. The sealing element is designed as a helical spring sealing element arranged extending coaxially to the axis of rotation and arranged in a circumferential groove of the retaining element and twists proportionally to the frictional resistance between the helical spring sealing element and the sealing surface. Contact surface pressure is reduced between the helical spring sealing element and sealing surface.

### CROSS-REFERENCE TO RELATED APPLICATIONS

This continuation application claims priority to PCT/EP2016/080748 filed on Dec. 13, 2016 which has published as WO 2017/108496 A1 and also the German application number 10 2015 226 691.5 filed on Dec. 23, 2015, the entire contents of which are fully incorporated herein with these references.

### DESCRIPTION

### Field of the Invention

The invention relates to a rotary seal arrangement comprising two machine parts which are arranged to be rotatable relative to one another about an axis of rotation, wherein one of the two machine parts forms a seal retaining structure and the respective other of the two machine parts forms a sealing surface. The rotary seal arrangement comprises a rotary seal for sealing a sealing gap formed between the two machine parts, with an elastically deformable retaining element which is retained on or in the seal retaining structure of the one machine part and with a sealing element which bears in a sealing manner with a contact surface pressure on the sealing surface of the respective other machine part.

### BACKGROUND OF THE INVENTION

Such rotary seal arrangements are found in practice in a variety of technical applications and are used, for example, in drive systems.

During operation, the rotary seals of the rotary seal arrangements available on the market are subjected to a high mechanical load and optionally also to thermal load, not least due to the friction of the rotary seal on the assigned sealing surface, so that the rotary seals are subjected to a high level of wear. This may lead to malfunctions of the rotary seal arrangements and necessitates a high maintenance cost.

It is, therefore, the object of the invention to specify a rotary seal arrangement and a rotary seal in which excessive wear of the sealing element on the sealing surface is counteracted and thus the service life of the rotary seal arrangement/rotary seal is improved.

The object relating to the rotary seal arrangement is achieved by a rotary seal arrangement having the features specified in the independent claim. The rotary seal has the features specified in another claim. Advantageous developments of the invention form the subject-matter of the subclaims and the description.

### SUMMARY OF THE INVENTION

In the rotary seal arrangement according to the invention, the sealing element of the rotary seal is designed as a helical spring sealing element. The helical spring sealing element is arranged extending coaxially to the axis of rotation and is arranged in a circumferential groove of the retaining element in such a way that, with a rotational movement and/or by means of a rotational movement of the machine parts relative to one another, the helical spring sealing element twists proportionally to the friction and/or a frictional resistance between the helical spring sealing element and the sealing surface of the respective other machine part and (as a result) the (contact) surface pressure is reduced between the helical spring sealing element and the sealing surface. In other words, the helical spring sealing element is increasingly twisted by a greater friction between the helical spring sealing element and the sealing surface and/or a greater frictional resistance, such that the surface pressure between the helical spring sealing element and the sealing surface is reduced. The torsion of the helical spring element, which is transmitted and/or controlled by friction, causes a deformation and thus an alteration of the (active) cross section of the helical spring element, by which the helical spring element bearing against the sealing surface is able to be relieved of load. As a result, during the operation of the rotary seal arrangement the friction between the helical spring element and the sealing surface may be limited and/or adjusted as a whole to a predetermined friction, i.e. the frictional resistance limiting the rotational movement of the two machine parts may be limited and/or adjusted to a predetermined frictional resistance. The rotary seal thus has a self-protecting system relative to excessive friction on the sealing surface. As a result, excessive stress of the sealing element due to friction on the sealing surface and thus wear of the sealing element may be effectively counteracted. Consequently, the service life of the rotary seal and thus the rotary seal arrangement may be significantly improved. The friction-controlled automatic relief properties of the helical spring sealing element may be set by a correspondingly selected spring characteristic curve and/or spring constant of the helical spring sealing element. If the friction and/or the frictional resistance is reduced between the helical spring sealing element and the sealing surface, the helical spring sealing element is correspondingly twisted to a lesser extent and relieved of load.

According to the invention, the helical spring sealing element of the rotary seal arrangement may bear against the sealing surface of one of the two machine parts on the internal circumferential side or alternatively on the external circumferential side. In the first-mentioned case it is an internally sealing rotary seal and in the last-mentioned case it is an externally sealing rotary seal. As a result, the rotary seal arrangement may cover a wide range of technical applications.

The circumferential groove of the retaining element for the helical spring sealing element preferably has at least at one end a first rotary stop for the helical spring sealing element. As a result, the helical spring element may be supported on the stop such that said stop is twisted by the rotary movement of the rotatably mounted machine part in a first rotational direction—transmitted by friction—and by the deformation associated therewith the contact surface pressure between the helical spring element and the sealing surface is reduced. If the rotary seal arrangement for a bi-directional rotary movement is rotatable relative to the respective other machine part, i.e. both in a first rotational direction and in a second rotational direction counter to the first rotational direction, the retaining element preferably has a second rotary stop.

If the rotary seal is designed to be externally sealing, the helical spring sealing element is preferably retained fixed in position by at least one of its free ends on the retaining element. As a result, when the predetermined frictional resistance of the helical spring sealing element on the sealing surface is exceeded/reached, the helical spring sealing element may be twisted such that the helical spring sealing element is compressed in the radial direction and thus the contact surface pressure of the helical spring sealing element against the sealing surface is reduced.

The helical spring sealing element is arranged so as to be retained, preferably positively or non-positively, in the circumferential groove of the retaining element. As a result, a reliable seal of the sealing gap may be ensured. In the case of the sealing gap being subjected to pressure, for example with oil, the helical spring element may be supported over its entire helical extent on the groove flank of the retaining element on the low pressure side. In this case, the elastic properties of the retaining element always ensure a sealed axial bearing of the helical spring element on the retaining element. Minor irregularities of the helical spring sealing element may be reliably compensated by the retaining element.

In principle, the helical spring element may be mounted in the pretensioned state on the sealing surface so that the contact surface pressure, by which the helical spring sealing element bears against the sealing surface of one of the two machine parts, at least partially results from the inherent elastic restoring capacity of the helical spring element.

According to the invention, the helical spring sealing element may be alternatively or additionally pretensioned against the sealing surface by the elastic retaining element. The retaining element in this case has the function of a pretensioning element acting in the radial direction.

The service life of the rotary seal arrangement according to the invention may be further improved by the helical spring sealing element having a flute and/or groove on its circumferential surface bearing against the sealing surface, said flute and/or groove being preferably arranged to extend in a helical manner relative to the axis of rotation. During the operation of the rotary seal arrangement, an active return flow of a fluid arranged in the sealing gap, for example a lubricant, may be achieved by means of such a flute/groove. As a result, partial or full lubrication of the rotary seal may be achieved in the bearing region of the helical spring sealing element on the sealing surface which is susceptible to wear.

According to an alternative embodiment of the invention, the helical spring sealing element may also be provided with dry lubricant. As a result, an operation of the rotary seal arrangement which requires particularly low maintenance is possible.

The helical spring sealing element according to the invention may consist of a thermoplastic or a thermosetting plastics material, a composite material or metal. As a result, the rotary seal arrangement may be designed for the external influences of a chemical or physical nature to be anticipated during operation.

For a precise response characteristic of the rotary seal, the helical spring element and/or the retaining element are advantageously provided with an anti-friction coating. The anti-friction coating may, for example, comprise graphite or PTFR (polytetrafluoroethylene).

The rotary seal according to the invention for a rotary seal arrangement described above has an elastically deformable retaining element with a circumferential groove, a sealing element which is configured as a helical spring sealing element being arranged therein. The circumferential groove of the retaining element preferably has in each case a rotary stop for the front faces and/or the end portions of the helical spring element. The rotary seal may be used and/or retrofitted in the case of a plurality of rotary seal arrangements. As a result, the service life and the reliability of the rotary seal arrangements may be improved in a cost-effective manner and the required maintenance cost reduced.

### BRIEF DESCRIPTION OF THE DRAWINGS

The invention is described in more detail hereinafter with reference to the exemplary embodiments shown in the drawings, in which:

FIG. 1 shows a rotary seal arrangement comprising a first and a second machine part and comprising a sealing element which is configured as a helical spring sealing element and which is designed to be radially internally sealing and which is arranged in a circumferential groove of an elastically deformable retaining element, in a partial longitudinal section;

FIG. 2 shows the rotary seal arrangement of FIG. 1 with a view of a rotational relative position of the helical spring sealing element relative to the retaining element in a partially sectional side view;

FIG. 3 shows the rotary seal arrangement of FIG. 1 in partial cross section;

FIG. 4 shows the rotary seal arrangement of FIG. 1 in which the internal machine part in the radial direction is rotated in a first rotational direction, with the activated helical spring sealing element, in a detailed sectional view;

FIG. 5 shows the rotary seal arrangement of FIG. 4 in a partial cross section;

FIG. 6 shows the rotary seal arrangement of FIG. 1 in a further rotational direction of the internal machine part in the radial direction, in a side view with a partial sectional view;

FIG. 7 shows a further rotary seal arrangement in which the seal is designed to be externally sealing in the radial direction; in a partial sectional view;

FIG. 8 shows the rotary seal arrangement of FIG. 7 in a cross section;

FIG. 9 shows an alternative embodiment of the helical spring sealing element of the rotary seal arrangements according to FIGS. 1 to 8, in a sectional view; and

FIG. 10 shows an alternative embodiment of the helical spring sealing element of the rotary seal arrangements according to FIGS. 1 to 8, in a sectional view.

### DETAILED DESCRIPTION OF THE PREFERRED EMBODIMENTS

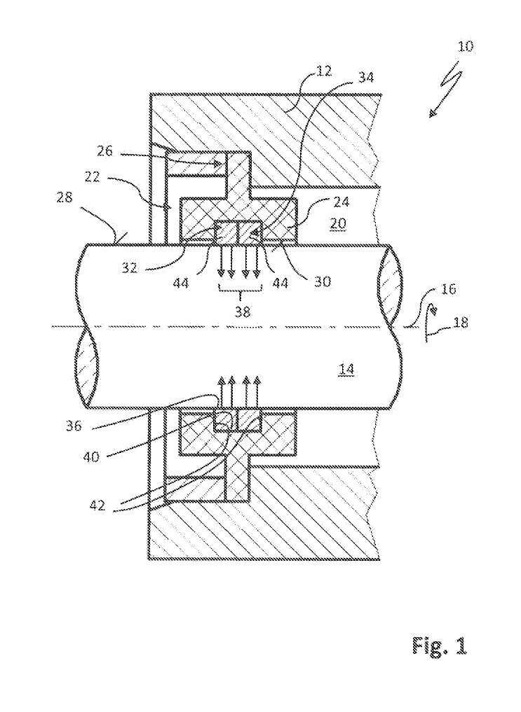

FIG. 1 shows a rotary seal arrangement 10 comprising a first and a second machine part 12, 14 which are arranged coaxially to an axis of rotation 16. The second machine part 14 is rotatably mounted relative to the first machine part 12 about the axis of rotation 16. A first rotational direction (clockwise) of the second machine part is denoted by 18. The first machine part 12 is configured as a housing which encompasses in an annular manner the second machine part 14 which is arranged on the inside in the radial direction. The second machine part 14 may have and/or form a bearing for the second machine part (not shown in FIG. 1).

An annular sealing gap 20 is formed between the two machine parts 12, 14. A rotary seal 22 is used for sealing the sealing gap 20, said rotary seal having an elastically deformable and/or elastomer retaining element 24 and a sealing element.

The first machine element 12 has a seal retaining structure 26 which in the present case is configured as a groove. In the seal retaining structure 26, the retaining element of the rotary seal 22 is secured and/or fastened fixedly in terms of rotation to the first machine part 12. The second machine part 14 has a sealing surface 28 which is formed by the outer envelope surface of the second machine part 14. The elastically deformable retaining element 24 has a circumferential groove 32 on its surface 30 facing the sealing surface 28. The sealing element is arranged so as to be retained in the circumferential groove 32. The sealing element protrudes in the radial direction from the circumferential groove 32 and bears sealingly against the sealing surface 28 of the second machine part 14 in a pretensioned manner.

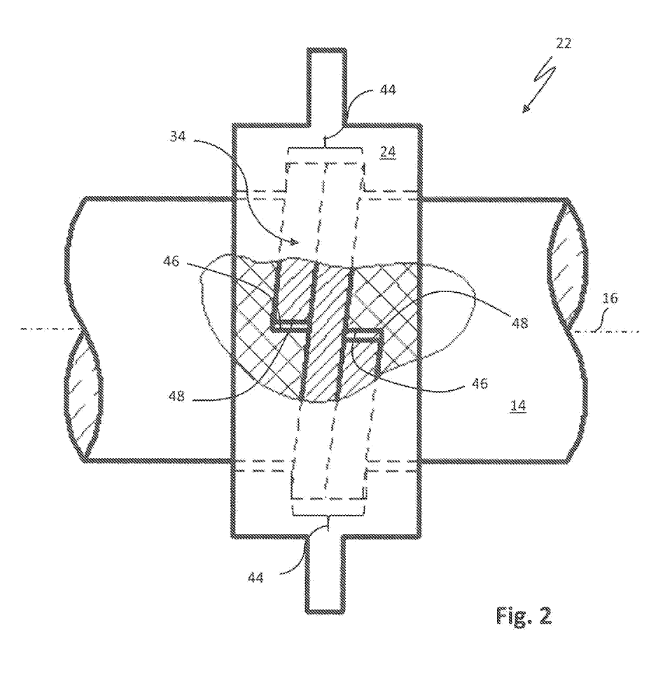

The sealing element is configured as a helical spring sealing element 34. The helical spring sealing element 34 is arranged coaxially to the axis of rotation 16 and encompasses the second machine part 14 in an annular manner. The helical spring sealing element 34 bears on the internal circumferential side, i.e. with its internal circumferential surface 36, against the sealing surface 28 with a contact surface pressure 38 indicated by arrows, against the sealing surface 28 of the second machine part. The contact surface pressure 38 of the helical spring sealing element 34 against the sealing surface 28 may be produced by the elastic restoring characteristics of the helical spring itself and/or by a radially oriented pretensioning of the helical spring sealing element 34 by means of the retaining element 24. The helical spring sealing element 34 in the present case bears with the elastic restoring force inherent thereto, and additionally assisted by the retaining element 24, against the sealing surface 28 in a pretensioned and sealing manner. The helical spring sealing element accordingly bears against a groove base 40 of the circumferential groove 32 of the retaining element 24 without clearance. The helical spring sealing element 34 is retained positively or non-positively between groove flanks 42 of the circumferential groove 32 in the axial direction. As a result, a reliable seal of the sealing gap 20 in the axial direction is achieved in this region. For the purpose of low sliding friction and/or static friction between the helical spring sealing element 34 and the retaining element 24, the helical spring sealing element 34 may be coated with an anti-friction coating (not shown in FIG. 2).

In FIG. 2 the rotary seal 22 and the second machine part 14 of the rotary seal arrangement 10 according to FIG. 1 are cut away and shown in a detailed sectional view. The helical spring sealing element 34 by way of example has a total of two windings 44. It goes without saying that the helical spring sealing element 34, if required, may also have further windings 44.

The circumferential groove 32 of the retaining element 30 is defined on the front face (in the circumferential direction) by wall portions which in each case form a rotary stop 46 for the helical spring sealing element 34. As a result, in the mounted state of the rotary seal arrangement the helical spring element is, on the one hand, captively retained in the circumferential groove of the retaining element. In the operating state of the rotary seal arrangement, shown in FIG. 2, the helical spring sealing element 34 is not twisted and/or only insignificantly twisted by the frictional resistance on the sealing surface 28, so that the helical spring sealing element 34 with its front faces 48 is in each case arranged spaced apart from the rotary stops 46 of the retaining element.

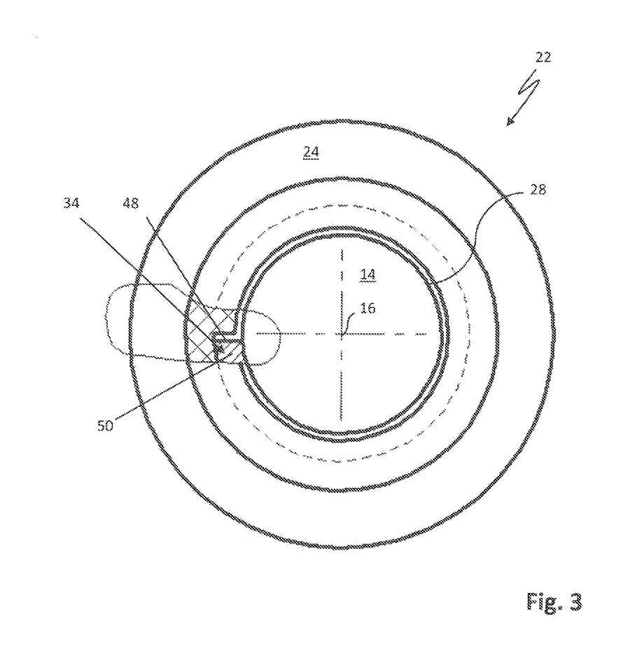

FIG. 3 shows the rotary seal 22 and the second machine part 14 of the rotary seal arrangement 10 according to FIG. 1 in a cut-away and partially sectional view on the front face. It may be clearly seen that the helical spring sealing element 34 protrudes from the circumferential groove 32 of the retaining element 24 radially in the direction of, and counter to, the sealing surface 28.

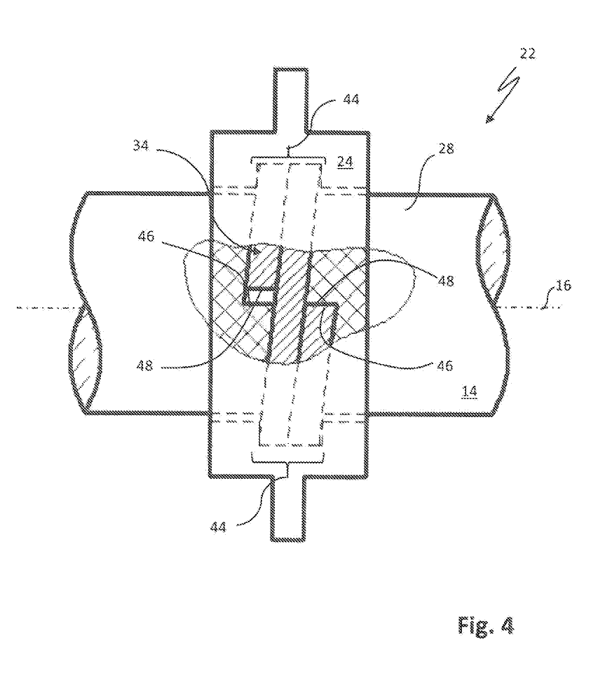

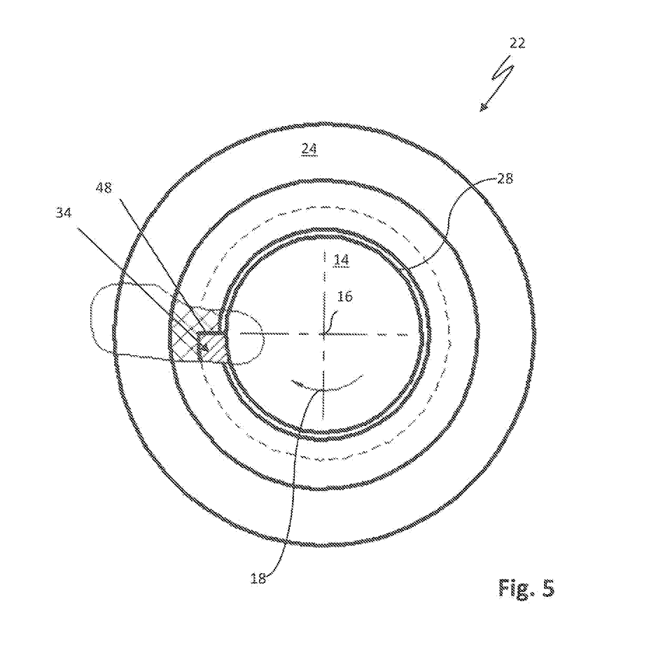

In FIGS. 4 and 5 the rotary seal arrangement 10 is shown in an operating state in which the seal which is configured as a helical spring sealing element 34 is entrained in the rotational direction 18 by an increased friction and/or an increased frictional resistance between the helical spring sealing element 34 and the sealing surface—by overcoming a frictional resistance existing between the helical spring sealing element 34 and the retaining element 24—by the second machine part 14 rotating in the first rotational direction 18 (FIG. 1) and with its front face 48 facing in each case in the rotational direction 18 being guided counter to the rotary stop 46 of the retaining element 24 assigned to the front face 48.

Due to the friction existing between the helical spring sealing element 34 and the sealing surface 28 and/or the resulting frictional resistance, the helical spring sealing element 34 which is supported on the rotary stop 46 is subjected to a torsional force, resulting from the rotational movement of the second machine part 14, and is twisted. The torsion of the helical spring sealing element 34 behaves proportionally to the frictional resistance between the sealing surface and the helical spring sealing element 34 bearing thereagainst—according to the selected spring characteristic curve of the helical spring element 34. The helical spring sealing element 34 is as a result widened in the radial direction—counter to the elastic restoring capacity inherent to the helical spring sealing element 34 and the radial force of the retaining element 24 acting in an inwardly oriented manner toward the helical spring sealing element 34—and as a result the surface pressure between the helical spring sealing element 34 and the sealing surface 28 is reduced. As a result, the friction between the helical spring sealing element and the sealing surface 28 and thus the frictional resistance is limited to a predetermined friction and/or predetermined frictional resistance. Consequently, the rotary seal 22 of the rotary seal arrangement 10 has thereby a self-protecting mechanism, by which the helical spring sealing element 34 during operation is protected from excessive (mechanical and thermal) load caused by friction.

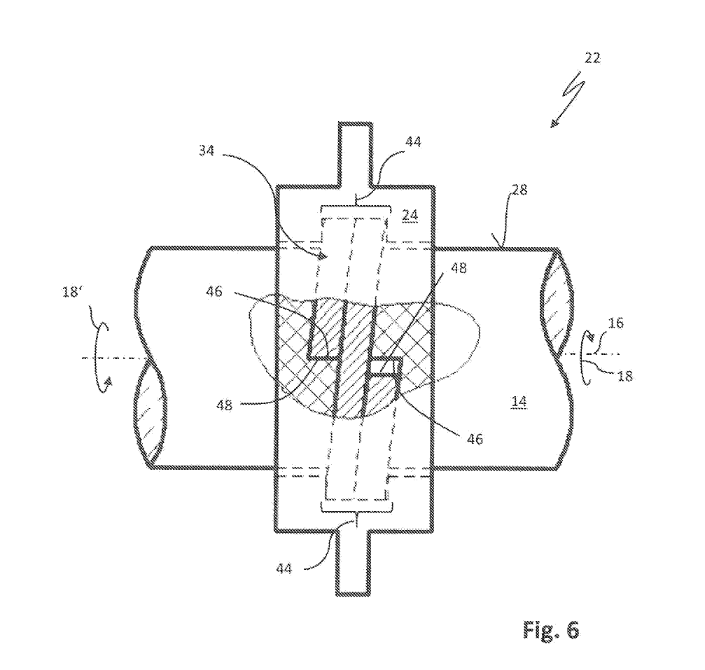

FIG. 6 shows the above-described rotary seal arrangement 10 in an operating state in which the rotatably mounted machine part 14 is moved in a rotational direction 18′ counter to the first rotational direction and in the activated, i.e. twisted state. The helical spring sealing element 34 of the rotary seal 22 in this case is supported in a manner similar to the above embodiments, with its front face 48 facing in the rotational direction 18′ on the associated rotary stop 46 of the retaining element 24.

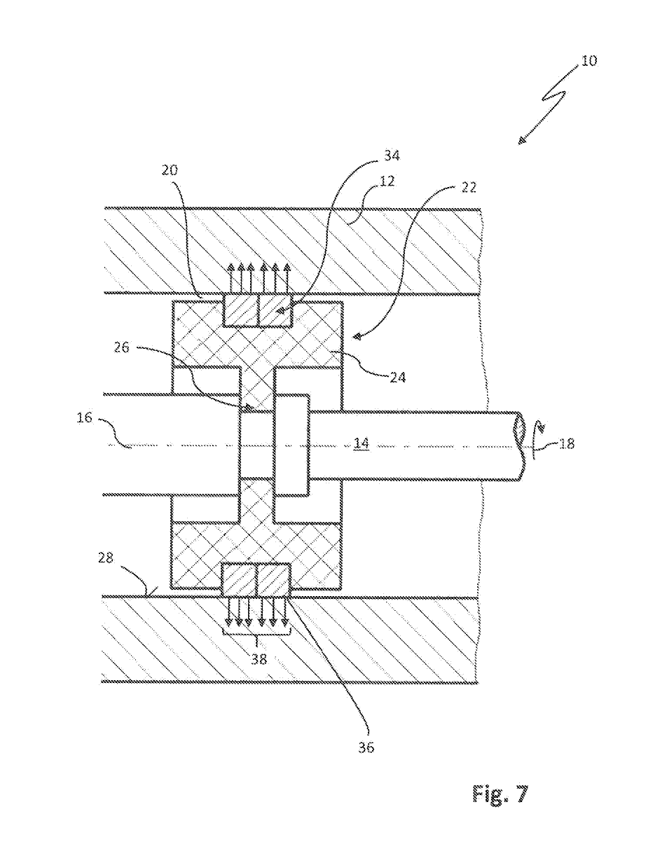

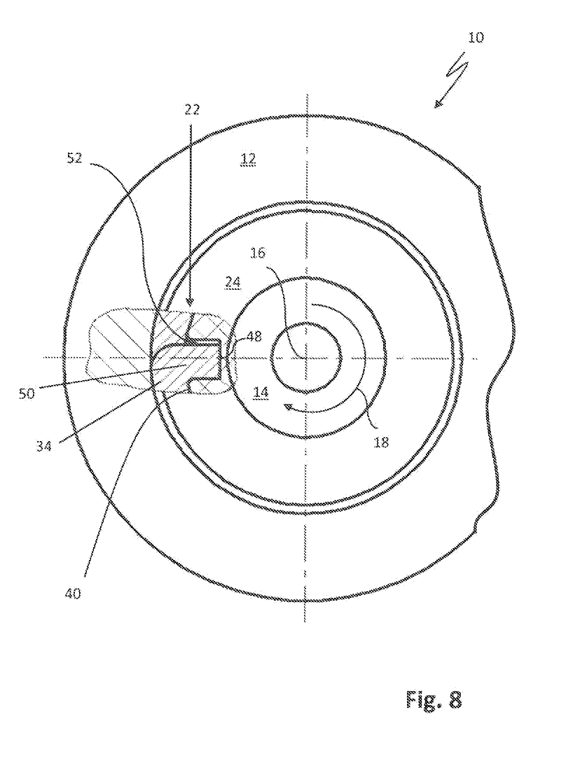

The above-described functional principle may be implemented according to the embodiment of the invention shown in FIGS. 7 and 8, even in the case of a rotary seal arrangement 10 with a radially externally sealing rotary seal 22. The retaining element 24 in this case is fastened to a seal retaining structure 26 of the second machine part 14, i.e. arranged internally in the radial direction. The sealing element which is configured as a helical spring sealing element 34 bears sealingly against the sealing surface 28 of the first machine part 12. In contrast to the rotary seal arrangement shown in FIGS. 1 to 6, the helical spring sealing element 34 is relieved of load for protection from excessive stress due to friction on the sealing surface 28 by means of a torsionally induced and radially inwardly oriented compression when it bears against the sealing surface. According to FIG. 8 the helical spring sealing element 34 is secured to the retaining element 24 with its free end portion 50 oriented counter to the rotational direction 18. The free end portion 50 may be angled back relative thereto and engage in a recess 52 of the groove base 40, as shown in FIG. 8. It is also conceivable that the free end portion 50 of the helical spring sealing element 34 engages in a recess of one of the two groove flanks 42 of the circumferential groove 34 or is fastened in a different manner to the retaining element 24.

If the frictional resistance between the helical spring sealing element 34 and the first machine part 12 reaches and/or exceeds the predetermined frictional resistance value, the helical spring sealing element 34 is entrained in the rotational direction, optionally counter to a frictional resistance existing between the helical spring sealing element and the retaining element—by the second machine part 12 rotating in the first rotational direction (FIG. 1) and is twisted such that the helical spring sealing element 34 in the radial direction—counter to the elastic restoring capacity inherent to the helical spring sealing element 34 (the restoring force oriented radially outwardly) and a radial force of the retaining element 24 optionally acting on the helical spring sealing element 34—is compressed in the radial direction so that the contact surface pressure 38 between the helical spring sealing element 34 and the sealing surface 28 is reduced.

The helical spring sealing element 34 may consist, in particular, of PTFE (polytetrafluoroethylene) or a different suitable plastics and/or a composite material. The retaining element 24 preferably consists of a rubber-elastic deformable material, for example PU (polyurethane) or the like.

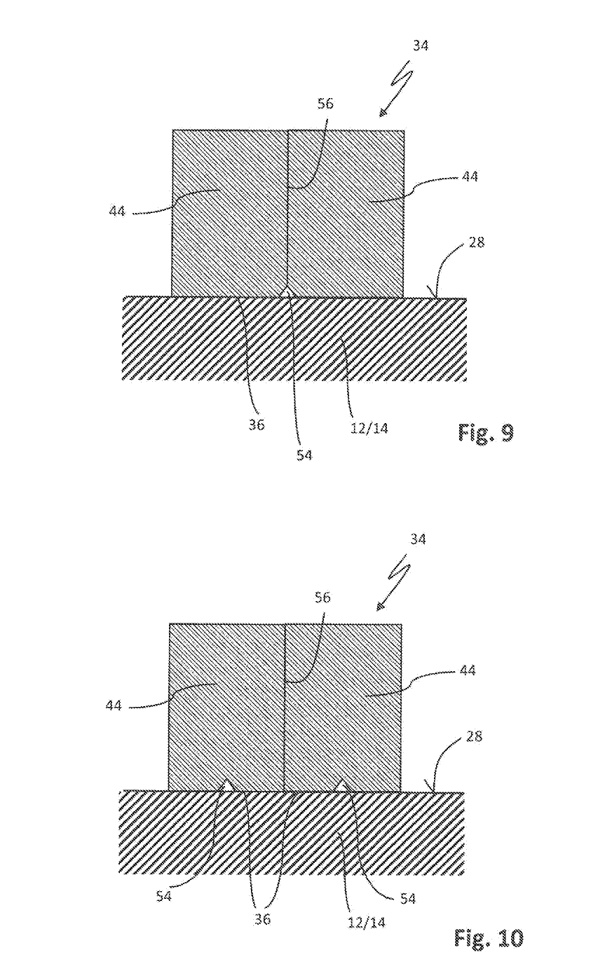

The helical spring sealing elements 34 of the rotary seal arrangements 10 described above in connection with FIGS. 1 to 8 in each case may have one or more grooves and/or flutes which may be arranged to extend in a helical and/or spiral-shaped manner to the axis of rotation 16. As a result, with a rotation of the machine part 12, 14 which is rotatable about the axis of rotation 16, a return flow of a fluid arranged in the sealing gap, for example lubricating oil, may be achieved via the helical spring sealing element 34. According to FIG. 9, a groove and/or flute 54, for example, may be aligned in the radial direction with the spiral-shaped bearing region 56 of the individual windings 44 of the helical spring sealing element 34. Alternatively or additionally, the spiral-shaped groove/flute 54 in the circumferential surface 36 of the helical spring element 34 may be arranged axially offset to the bearing region 56, as is shown in FIG. 10. The grooves/flute 54 shown in FIG. 10 in this case has a pitch (not illustrated in FIG. 10) which corresponds to the pitch of the helical spring element 34. The returnable quantity of lubricating oil may be further increased by a plurality of the aforementioned grooves/flutes 54.

What is claimed is:

1. A rotary seal arrangement, comprising:
two machine parts which are arranged to be rotatable relative to one another about an axis of rotation;
wherein one of the two machine parts forms a seal retaining structure and the respective other of the two machine parts forms a sealing surface;
a rotary seal for sealing a sealing gap formed between the two machine parts;
a retaining element which consists of a rubber-elastic deformable material and which is retained on the seal retaining structure of the one machine part and with a sealing element which bears in a sealing manner with a surface pressure against the sealing surface of the other machine part;
wherein the sealing element is designed as a helical spring sealing element which is arranged extending coaxially to the axis of rotation and, wherein the helical spring sealing element is arranged so as to be retained positively or non-positively in a circumferential groove of the retaining element in the axial direction and which is tensioned by the elastic retaining element in the radial direction against the sealing surface;
wherein the circumferential groove of the retaining element at one end has a first rotary stop for the helical spring sealing element, wherein the helical spring sealing element is arranged in the circumferential groove such that, with a rotational movement of the machine parts relative to one another, the helical spring sealing element twists proportionally to the frictional resistance between the helical spring sealing element and the sealing surface and the contact surface pressure is reduced between the helical spring sealing element and the sealing surface.

2. The rotary seal arrangement as claimed in claim 1, wherein the helical spring sealing element bears sealingly against the sealing surface on the internal circumferential side.

3. The rotary seal arrangement as claimed in claim 1, wherein the circumferential groove of the retaining element at the other end has a second rotary stop for the helical spring sealing element.

4. The rotary seal arrangement as claimed in claim 1, wherein the helical spring sealing element bears against the sealing surface on the external circumferential side.

5. The rotary seal arrangement as claimed in claim 4, wherein the helical spring sealing element is retained fixed in position by at least one of its free end portions, or by both of its free end portions, on the retaining element.

6. The rotary seal arrangement as claimed in claim 1, wherein the helical spring sealing element bears sealingly against the sealing surface in a pretensioned manner due to its resilient restoring capacity.

7. The rotary seal arrangement as claimed in claim 1, wherein the helical spring sealing element has a flute on its circumferential surface bearing against the sealing surface, said flute being arranged to extend in a helical manner relative to the axis of rotation.

8. The rotary seal arrangement as claimed in claim 1, wherein the helical spring sealing element consists of a thermoplastic, a thermosetting plastics material, a composite material or a metal.

9. The rotary seal arrangement as claimed in claim 1, wherein the helical spring sealing element and/or the retaining element is/are provided with an anti-friction coating.

10. The rotary seal arrangement as claimed in claim 1, comprising an elastically deformable retaining part with the circumferential groove, wherein the sealing element, which is configured as the helical spring sealing element, is arranged in the circumferential groove.
